(19) United States
(12) Patent Application Publication
(10) Pub. No.: US 2006/0033029 A1
(43) Pub. Date: Feb. 16, 2006

(54) Low-voltage, solid-state, ionizing-radiation detector

(75) Inventor: Ziv Popper, Zichron Yaakov (IL)

Correspondence Address: Martin MOYNIHAN;c/o ANTHONY CASTORINA, SUITE 207, 2001 JEFFERSON DAVIS HIGHWAY, ARLINGTON, VA, 22202, US

(73) Assignee: V-Target Technologies Ltd.

(21) Appl. No.: 10/917,357

(22) Filed: Aug. 13, 2004

(51) Int. Cl. G01T 1/24

(52) U.S. Cl. 250/370.01

(57) ABSTRACT

A stratified, solid-state detector for ionizing radiation, is provided, wherein an operating bias is applied in parallel to all the strata. Since the bias required for accelerating electrons away from holes in a solid-state material is generally a function of material thickness, a stack of thin solid-state-material layers, connected in parallel, will operate at only a fraction of the bias required for a single, thick layer of solid-state-material of an equivalent thickness. Thus, stratification allows for reduced operating voltage and improved manufacturing flexibility. Additionally, a high-voltage power supply need not be used, thus increasing the safety of the detector. Stratification may further provide information on incident-radiation energy, based on depth penetration into the detector, wherein the layers may operate as “depth pixels.” Generally, the higher the incident radiation energy, the greater the probability for deep penetration into the solid state material. The stratified, solid-state detector may be designed as a stack of relatively thin solid-state-material layers, each with dedicated electrical contacts, and electrical insulation between layers. Alternatively, the stratified detector may be designed as a stack of relatively thin solid-state-material layers, with thin electrode layers, alternating between positive and negative senses, between them. Alternatively, the stratified detector may be designed as a stack of relatively thin solid-state-material layers, with thin electrode strips between them, wherein the electrode strips form a weave: at one layer the electrode strips are positive, running in a first direction, and at another, the electrode strips are negative, and running in a direction orthogonal to the positive strips. In effect, the weave electrode structure forms a pixel-like structure from single-pixel solid-state-material layers. The incident radiation may be orthogonal to or parallel with the stack of solid-state-material layers.

### FIELD AND BACKGROUND OF THE INVENTION

The present invention relates to a solid-state detector for ionizing radiation, and more particularly, to a stratified, solid-state detector.

Solid-state detectors have been used in biology and radiopharmacology since the early 1960's. A solid-state detector is formed as a crystal composed of an electron-rich sector, known as the n-type or electron conductor, and an electron-deficient sector, known as the p-type or hole conductor. When reverse-bias voltage is applied, a central region absent of free charge, also known as the depletion region, is formed within the crystal. When a charged particle or photon enters the depletion region, it interacts with the semiconducting material to form hole-electron pairs. These holes and electrons are swept out of the depletion region by the electric field. The magnitude of the resultant pulse in the external circuit is directly proportional to the energy lost by the ionizing radiation in the depletion region.

In general, the detector's sensitivity is affected by the following factors:

1. Detector thickness: At relatively high photon energies, the probability of a photon creating an electron-hole pair is proportional to the length traveled through the detector material, which in turn is affected by the material's thickness.

2. Crystal Purity: Electron and hole mobility, which is important in order to prevent recombination, is affected by the purity of the detector material. The higher the purity, the greater the mobility. For the purpose of ionizing radiation detection, electron mobility should be at least an order of magnitude greater than hole mobility.

3. Voltage drop: A high voltage drop, of about 100 volts per mm of detector material thickness is required to accelerate the electrons away from the holes, in order to minimize recombination.

High-efficiency, solid-state, radioactive-emission detectors are known. For example, room temperature CdZnTe detectors may be obtained from IMARAD IMAGING SYSTEMS LTD., of Rehovot, ISRAEL, 76124, www.imarad.com. Similarly, they may be obtained from eV Products, a division of II-VI Corporation, Saxonburg, Pa. 16056. Other solid-state, radioactive-emission detectors include, for example, CdTe, HgI, Si, Ge, and the like. They are operable in single-pixel or multi-pixel arrangements, with pixel size varying from about 3×3 mm to about 5×5 mm. A single pixel of between about 3 and about 15 mm in diameter may similarly be used. It will be appreciated that other dimensions are possible and may be used.

Generally, each pixel is equipped with positive and negative contacts, although often, the negative contacts are wired so as to be common to all pixels. Additionally, each pixel is connected to a preamplifier.

The room temperature solid-state CdZnTe (CZT) detector is among the more promising nuclear detector currently available. It has a better count-rate capability than other detectors on the market, and its pixilated structure provides intrinsic spatial resolution. Furthermore, because of the direct conversion of the gamma photon to charge-carriers, energy resolution is enhanced and there is better rejection of scatter events and improved contrast.

Nonetheless, present-day solid-state detectors for ionizing radiation operate at a relatively high bias, so as to affect both the cost and the overall volume of a detector system. Additionally, they do not provide information regarding the depth of penetration of the incident radiation into the detector material.

### SUMMARY OF THE INVENTION

The present invention successfully addresses the shortcomings of presently known configurations by providing a stratified, solid-state detector for ionizing radiation, wherein an operating bias is applied in parallel to all the strata. Since the bias required for accelerating electrons away from holes in a solid-state material is generally a function of material thickness, a stack of thin solid-state-material layers, connected in parallel, will operate at only a fraction of the bias required for a single, thick layer of solid-state-material of an equivalent thickness. Thus, stratification allows for reduced operating voltage and improved manufacturing flexibility. Additionally, a high-voltage power supply need not be used, thus increasing the safety of the detector. Stratification may further provide information on incident-radiation energy, based on depth penetration into the detector, wherein the layers may operate as “depth pixels.” Generally, the higher the incident radiation energy, the greater the probability for deep penetration into the solid state material. The stratified, solid-state detector may be designed as a stack of relatively thin solid-state-material layers, each with dedicated electrical contacts, and electrical insulation between layers. Alternatively, the stratified detector may be designed as a stack of relatively thin solid-state-material layers, with thin electrode layers, alternating between positive and negative senses, between them. Alternatively, the stratified detector may be designed as a stack of relatively thin solid-state-material layers, with thin electrode strips between them, wherein the electrode strips form a weave: at one layer the electrode strips are positive, running in a first direction, and at another, the electrode strips are negative, and running in a direction orthogonal to the positive strips. In effect, the weave electrode structure forms a pixel-like structure from single-pixel solid-state-material layers. The incident radiation may be orthogonal to or parallel with the stack of solid-state-material layers.

In accordance with one aspect of the present invention, there is thus provided a stratified solid-state detector, comprising:
a first solid-state-material layer, defining an x;y plane of an x;y;z coordinate system, and proximal and distal surfaces, proximally being the direction of positive z;
a second solid-state-material layer, distal to and parallel with the first layer and forming a stack therewith;
a first separating layer, arranged between the first and second solid-state-material layers; and
a bias, applied to the first and second solid-state-material layers, in parallel.

In accordance with an additional aspect of the present invention, the stratified solid-state detector is arranged for detecting ionizing radiation incident on the x;y plane.

In accordance with an alternative aspect of the present invention, the stratified solid-state detector is arranged for detecting ionizing radiation incident on a plane orthogonal to the x;y plane.

In accordance with an alternative aspect of the present invention, the stratified solid-state detector is arranged for detecting ionizing radiation incident on the x;y plane and on at least one plane orthogonal to it.

In accordance with an alternative aspect of the present invention, the stratified solid-state detector is arranged for detecting ionizing radiation incident on the x;y plane and on at least two planes orthogonal to it.

In accordance with an additional aspect of the present invention, each of the solid-state-material layers has positive and negative electrode connections.

In accordance with an additional aspect of the present invention, the first separating layer is a first insulating layer.

In accordance with an additional aspect of the present invention, the stratified solid-state detector further includes:
at least one other solid-state-material layer, distal to and parallel with the second layer; and
at least one other separating layer, arranged between the second and at least one other solid-state-material layers,
wherein the bias is applied to the at least one other solid-state-material layer, in parallel with the first and second solid-state-material layers.

In accordance with an additional aspect of the present invention, the at least one other separating layer is at least one other insulating layer.

In accordance with an alternative aspect of the present invention, the first and at least one other separating layers are electrode layers, of opposite senses, and further including:
a proximal-most electrode layer, arranged on the proximal surface of the first solid-state-material layer, and being of an opposite sense to the electrode layer forming the first separating layer; and
a distal-most electrode layer, arranged on a distal surface of the at least one other solid-state-material layer, and being of an opposite sense to the electrode layer forming the at least one other separating layer.

In accordance with an alternative aspect of the present invention, the electrode layers are formed as electrode layer strips.

In accordance with an additional aspect of the present invention, positive electrode layer strips are arranged orthogonal to negative electrode layer strips.

In accordance with an additional aspect of the present invention, the stratified solid-state detector further includes:
a plurality of additional solid-state-material layers, distal to and parallel with the second layer; and
a plurality of additional separating layers, each arranged between adjacent solid-state-material layers, so that every two adjacent solid-state-material layers have one of the separating layers, between them,
wherein the bias is applied to the plurality of additional solid-state-material layers, in parallel with the first and second solid-state-material layers.

In accordance with an additional aspect of the present invention, the plurality of additional separating layers are a plurality of additional insulating layers.

In accordance with an alternative aspect of the present invention, the separating layers are electrode layers, and further including:
a proximal-most electrode layer, arranged on the proximal surface of the first solid-state-material layer; and
a distal-most electrode layer, arranged on a distal surface of a distal-most of the plurality of additional solid-state-material layers,
wherein adjacent electrode layers have opposite senses.

In accordance with an alternative aspect of the present invention, the electrode layers are formed as electrode-layer strips.

In accordance with an additional aspect of the present invention, positive electrode-layer strips are arranged orthogonal to negative electrode-layer strips.

In accordance with an additional aspect of the present invention, the solid-state-material layers are pixellated.

In accordance with an additional aspect of the present invention, signals of each of the solid-state-material layers are analyzed individually.

In accordance with an additional aspect of the present invention, signals of each of the solid-state-material layers are analyzed individually, to provide depth-penetration information.

In accordance with an additional aspect of the present invention, the solid-state-material layers are pixellated, and signals of each pixel in each of the solid-state-material layers are analyzed individually.

In accordance with one aspect of the present invention, there is thus provided a method of detecting ionizing radiation, comprising:
providing a stratified solid-state detector, which comprises:
   a first solid-state-material layer, defining an x;y plane of an x;y;z coordinate system, and proximal and distal surfaces, proximally being the direction of positive z;
   a second solid-state-material layer, distal to and parallel with the first layer and forming a stack therewith; and
   a first separating layer, arranged between the first and second solid-state-material layers;
applying a bias to the first and second solid-state-material layers, in parallel;
detecting ionizing radiation, incident on the detector.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A and 1B schematically illustrate solid-state detectors, as known;

FIGS. 2A-2C schematically illustrate stratified, single-pixel solid-state detectors, having insulating separating layers, and arranged for detecting ionizing radiation incident on a plane parallel with the stratification, in accordance with the present invention;

FIG. 3 schematically illustrates a stratified, multi-pixel solid-state detector, having insulating separating layers, and arranged for detecting ionizing radiation incident on a plane parallel with the stratification, in accordance with the present invention;

FIGS. 4A and 4B schematically illustrate two alternative wiring schemes for a stratified, multi-pixel solid-state detector, in accordance with the present invention;

FIGS. 5A-5B schematically illustrate a stratified, single-pixel solid-state detector, having insulating separating layers, and arranged for detecting ionizing radiation incident on planes parallel with or orthogonal to the stratification, in accordance with the present invention;

FIGS. 6A-6D schematically illustrate a stratified, single-pixel solid-state detector, having separating layers, operative as electrodes, and arranged for detecting ionizing radiation incident on planes parallel with or orthogonal to the stratification, in accordance with the present invention; and

FIGS. 7A-7D schematically illustrate a stratified, single-pixel solid-state detector, having separating layers, operative as electrode-layer strips, and arranged for detecting ionizing radiation incident on planes parallel with or orthogonal to the stratification, in accordance with the present invention.

### DESCRIPTION OF THE PREFERRED EMBODIMENTS

The present invention is of a stratified, solid-state detector for ionizing radiation, wherein an operating bias is applied in parallel to all the strata. Since the bias required for accelerating electrons away from holes in a solid-state material is generally a function of material thickness, a stack of thin solid-state-material layers, connected in parallel, will operate at only a fraction of the bias required for a single, thick layer of solid-state-material of an equivalent thickness. Thus, stratification allows for reduced operating voltage and improved manufacturing flexibility. Additionally, a high-voltage power supply need not be used, thus increasing the safety of the detector. Stratification may further provide information on incident-radiation energy, based on depth penetration into the detector, wherein the layers may operate as “depth pixels.” Generally, the higher the incident radiation energy, the greater the probability for deep penetration into the solid state material. The stratified, solid-state detector may be designed as a stack of relatively thin solid-state-material layers, each with dedicated electrical contacts, and electrical insulation between layers. Alternatively, the stratified detector may be designed as a stack of relatively thin solid-state-material layers, with thin electrode layers, alternating between positive and negative senses, between them. Alternatively, the stratified detector may be designed as a stack of relatively thin solid-state-material layers, with thin electrode strips between them, wherein the electrode strips form a weave: at one layer the electrode strips are positive, running in a first direction, and at another, the electrode strips are negative, and running in a direction orthogonal to the positive strips. In effect, the weave electrode structure forms a pixel-like structure from single-pixel solid-state-material layers. The incident radiation may be orthogonal to or parallel with the stack of solid-state-material layers.

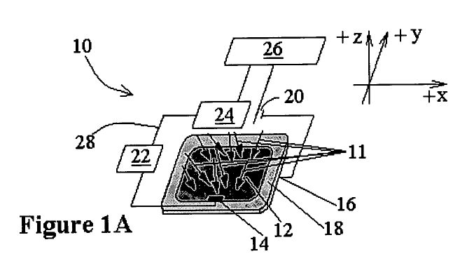

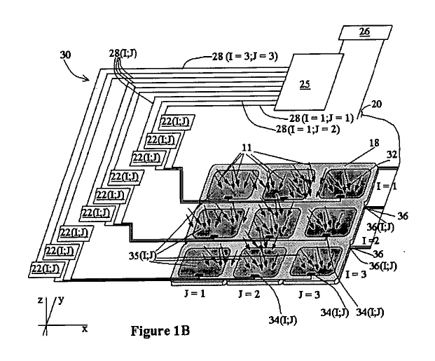

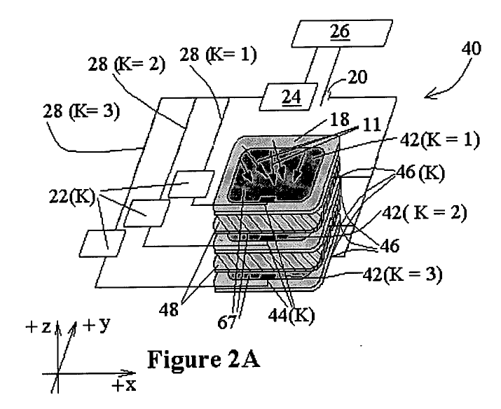

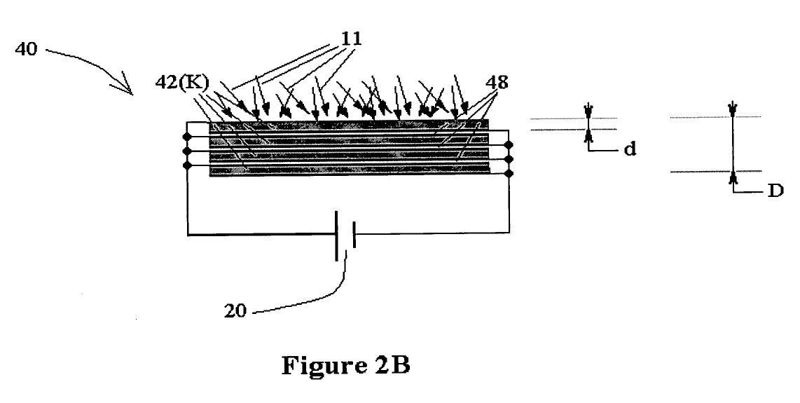

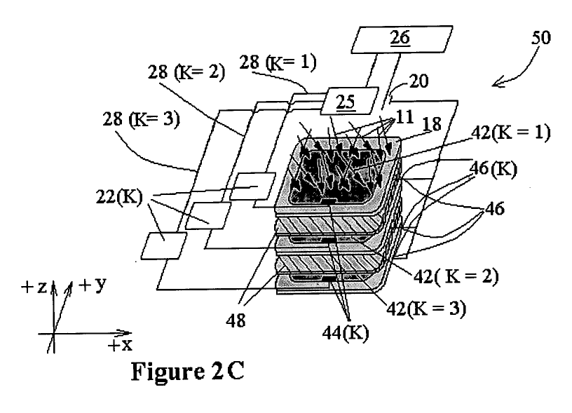

For purposes of better understanding the present invention, as illustrated in FIGS. 2A-7D of the drawings, reference is first made to the construction and operation of a conventional, i.e., prior art detectors, as illustrated in FIGS. 1A-1B.

FIG. 1A schematically illustrates a single-pixel, solid-state detector 10, as known, comprising a solid-state material 12, which defines an x;y plane of an x;y;z coordinate system, and which is arranged for detecting ionizing radiation 11 incident, for example, on the x;y plane, the solid-state material 12 having positive and negative electrode 14 and 16, respectively. Preferably, the solid-state material 12 is surrounded by an insulation material 18. Preferably, the solid-state material 12 is associated with a preamplifier 22. A wire 28 leads from preamplifier 22 to a counter 24, which receives power from a power supply 26. The power supply 26 further includes a second terminal 20, for setting a bias across the solid-state material 12. The solid-state material 12 may be, for example, a square, in the x;y plane, having sides of between about 3 mm and about 10 mm. Alternatively, another polygon, a circle, or another geometrical shape may be used. The depth, in the z direction, may be between about 0.1 mm and about 3 mm. It will be appreciated that other dimensions may similarly be used. Preferably, the bias is about 100 volts per mm for solid-state material thickness, for example, about 200 volts for a solid-state material of about 2 mm.

The solid-state material 12 may be, for example, room temperature CdZnTe. Alternatively, CdTe, HgI, Si, Ge, or the like may be used. The detector 10 may be obtained, for example, from IMARAD IMAGING SYSTEMS LTD., of Rehovot, ISRAEL, 76124, www.imarad.com, or from eV Products, a division of II-VI Corporation, Saxonburg Pa., 16056.

FIG. 1B schematically illustrates a multi-pixel, solid-state detector 30, as known, comprising a solid-state material 32, divided into a plurality of pixels 35(I;J), each surrounded by the insulation material 18. The pixels are arranged for detecting the ionizing radiation 11 incident on the x;y plane, and each includes positive and negative electrode connections 34(I;J) and 36(I;J), respectively. Each pixel 35(I;J) is associated with a preamplifier 22(I;J), and wires 28(I;J) lead from the preamplifiers 22(I;J) to a multi-channel counter 25, which receives power from the power supply 26. The power supply 26 further includes the second terminal 20, for setting the bias across the solid-state material 32. Preferably, the positive electrode connection 34(I;J) is individual to each of the pixels 35(I;J), but the negative connection 36(I;J), is common to all, and may be regarded as 36.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The principles and operation of the stratified solid-state detector for ionizing radiation, according to the present invention, may be better understood with reference to the drawings and accompanying descriptions.

Referring now to the drawings, 2A-2C schematically illustrate stratified, single-pixel solid-state detectors, having insulating separating layers, and arranged for detecting the ionizing radiation 11 incident on a plane parallel with the stratification, in accordance with the present invention.

FIG. 2A schematically illustrates a stratified, single-pixel, solid-state detector 40, in accordance with a first embodiment of the present invention. The stratified, single-pixel, solid-state detector 40 comprises at least two, and preferably a plurality of solid-state-material layers 42(K), along the x;y plane of the x;y;z coordinate system, so as to form a stack 67. A layer thickness, in the z direction, may be between about 0.5 and 1 mm, yet, thinner layers may be used where practical to manufacture.

The solid-state-material layers 42(K) are arranged, for example, for detecting the ionizing radiation 11 incident on the x;y plane and have positive and negative electrode connections 44(K) and 46(K), respectively, wherein negative connections 46(K) may be common, and regarded simply as negative connections 46. Preferably, each of the solid-state-material layers 42(K) is surrounded by the insulation material 18. Preferably, each of the solid-state-material layers 42(K) is associated with a preamplifier 22(K), and a wire 28(K) leads from preamplifier 22(K) to the counter 24, which receives power from the power supply 26. The power supply 26 further includes the second terminal 20, for applying the bias across each of the solid-state-material layers 42(K).

The solid-state-material layers 42(K) are insulated from one another by separating layers 48, which provide electrical insulation. The separating insulation layers 48 may be deposited on solid-state-material layers 42(K) by any one of various means, as known, and are preferably, very thin, for example, between about 1 and about 50 microns.

FIG. 2B schematically illustrates the manner of applying the bias across each of the solid-state-material layers 42(K), of the single-pixel, solid-state detector 40, in accordance with the present invention. Preferably, solid-state-material layers 42(K) are connected in parallel, and the same bias is applied to all the solid-state-material layers 42(K), wherein insulating layers 48 separate one layer 42(K) from another.

Preferably, a thickness “d” of layers 42(K) may be, for example, between about 0.5 and about 1 mm, yet, thinner layers may be used where practical to manufacture. It will be appreciated that other values, which may be larger or smaller, may similarly be used. Since the preferred bias value is 100 volts per mm of solid-state-material thickness, a bias of about 10 volts needs to be applied at the terminal 20, for a “d” value of about 1 mm.

Given for example, 10 layers, the arrangement in accordance with the present invention will require a bias of about 10 volts, while an equivalent system, which is not stratified will require a bias of about 100 volts.

Additionally, where a greater width “D” is desired, more layers may be added, in parallel, without increasing the applied bias.

As a consequence of the relatively low bias, the overall detector volume and price are lower than that for an equivalent system, formed as a solid unit. Additionally, the thin-layer design makes sporadic forms and shapes easier to manufacture.

FIG. 2C schematically illustrates a single-pixel, solid-state detector 50, in accordance with a second embodiment of the present invention, wherein layers 42(K) may be thought of as “depth pixels.” Accordingly, wires 28(K), associated with layers 42(K), lead to a multi-channel counter 25, wherein each layer 42(K) is assigned a channel. In this manner, information on the incident radiation energy may be obtained, since generally, the higher the incident radiation energy, the greater the depth of penetration into the detector material.

Each of the solid-state-material layers 42(K) may be, for example, a square, in the x;y plane, having sides of between about 3 mm and about 10 mm. It will be appreciated that other dimensions may similarly be used. It will be further appreciated that another polygon, a circle, or another geometrical shape may be used.

The solid-state-material layers 42(K) may be, for example, room temperature CdZnTe. Alternatively, CdTe, HgI, Si, Ge, or the like may be used.

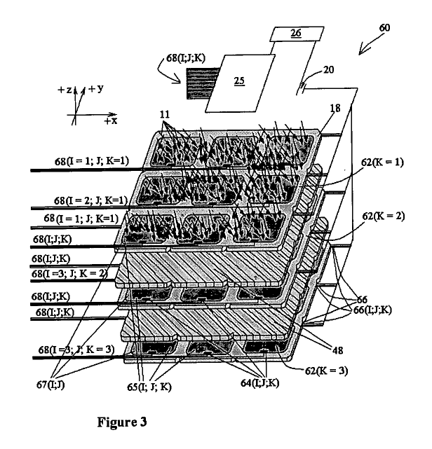

Referring furthering to the drawings, FIG. 3 schematically illustrates a stratified, multi-pixel solid-state detector, having insulating separating layers, and arranged for detecting the ionizing radiation 11 incident on a plane parallel with the stratification, in accordance with the present invention.

The multi-pixel, solid-state detector 60 comprises at least two, and preferably a plurality of solid-state-material layers 62(K), along the x;y plane of the x;y;z coordinate system, arranged for detecting the ionizing radiation 11 incident, preferably, on the x;y plane. Preferably, each of the solid-state-material layers 62(K) is divided into pixels 65(I;J;K), each of the pixels 65(I;J;K) having positive and negative electrode connections 64(I;J;K) and 66(I;J;K), respectively, wherein negative connections 66(I;J;K) may be common, and regarded simply as negative connections 66. Pixels 65(I;J;K) are surrounded by the insulation material 18. The insulation layers 48 separate the solid-state-material layers 62(K), and may be deposited on the solid-state-material layers 62(K), as known. As pointed out hereinabove, preferably, insulation layers 48 are very thin, for example, between about 1 and about 50 microns.

In accordance with the present invention, a pixel layer 67(I;J) includes all the pixels 65(I;J;K) of the same K value.

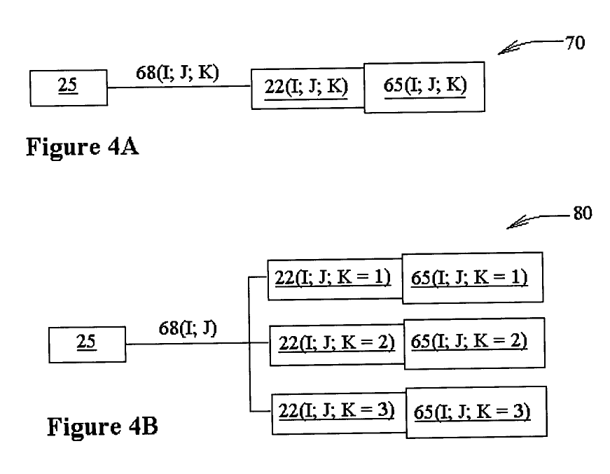

Referring furthering to the drawings, FIGS. 4A and 4B schematically illustrate two alternative wiring schemes for the stratified, multi-pixel, solid-state detector 60 of FIG. 3, in accordance with the present invention.

As seen in FIG. 4A, illustrating a wiring arrangement 70, each pixel 65(I;J;K) is associated with a preamplifier 22(I;J;K), which in turn in associated with a wire 68(I;J;K), leading to the multi-channel analyzer 25, of preferably at least I•J•K channels, thus providing information regarding the x;y location of the radiation source (not shown), and the energies of the incident radiation, based on the depth of penetration into the detector 60.

It will be appreciated that in the embodiment of FIG. 4A, the pixels in each of the layers 62(K) need not have the same x;y values, since information can be collected for each of the pixels individually, based on its exact position in the x;y;z coordinate system.

Alternatively, as seen in FIG. 4B, illustrating a wiring arrangement 80, each of the pixel 65(I;J;K) is associated with the preamplifier 22(I;J;K), but depth information is not collected. Rather, information for the pixel stacks 67(I;J) of all K values is combined into wires 68 (I;J), which lead to the multi-channel analyzer 25, having at least I•J channels. In this manner, x;y incident information may be obtained but depth of penetration into the detector is not evaluated.

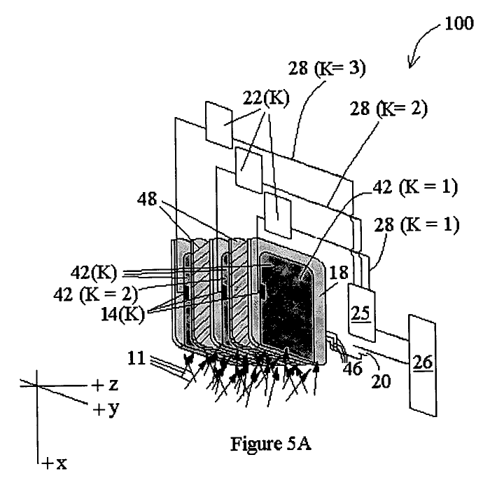

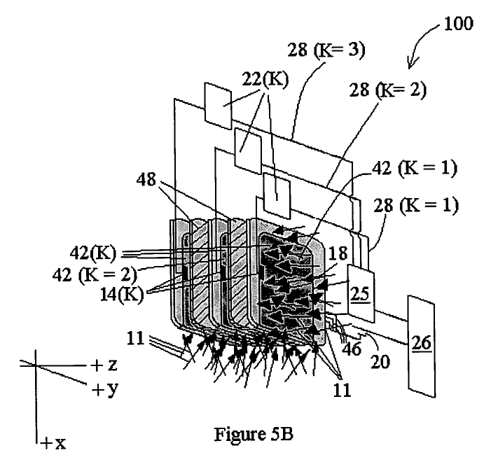

Referring further to the drawings, FIGS. 5A-5B schematically illustrate a stratified, single-pixel solid-state detector 100, in accordance with the present invention. The stratified, single-pixel solid-state detector 100 has insulating separating layers 48, and is arranged for detecting the ionizing radiation 11, incident on planes orthogonal to the stratification, for example, a plane y;z, in FIG. 5A, or on planes parallel with the stratification for example, a plane x;y, in FIG. 5B. Alternatively, a plane x;z or another edge plane may be used. It will be appreciated that the stratified, single-pixel solid-state detector 100 may be arranged for detecting the ionizing radiation 11, incident on several planes, simultaneously.

It will be appreciated that the embodiment of FIG. 5A provides some information as to the location of the source of the radiation 11, in the z direction, as layers 42(K) operate as one-dimensional pixels.

Yet in the embodiment of FIG. 5B, the radiation 11 may strike both the planes parallel with the stratification and the plane orthogonal to it, and the detector operates as a single unit, with no pixel information.

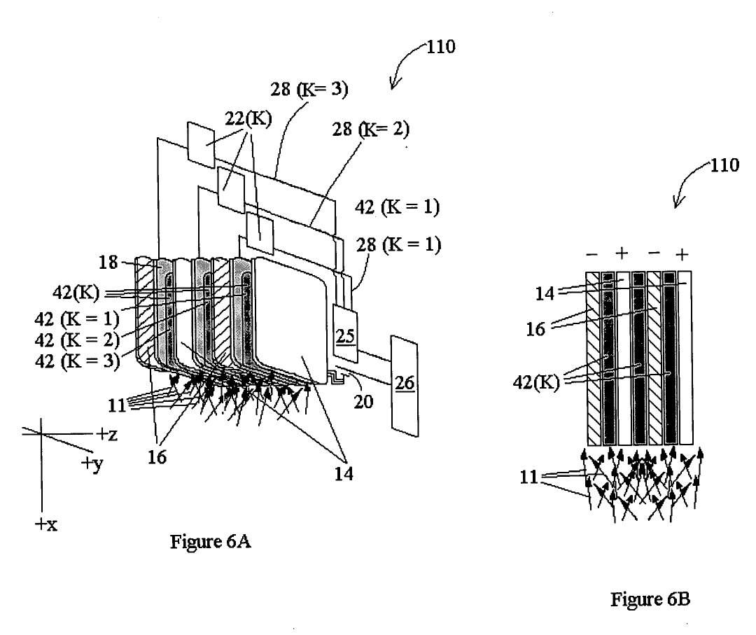

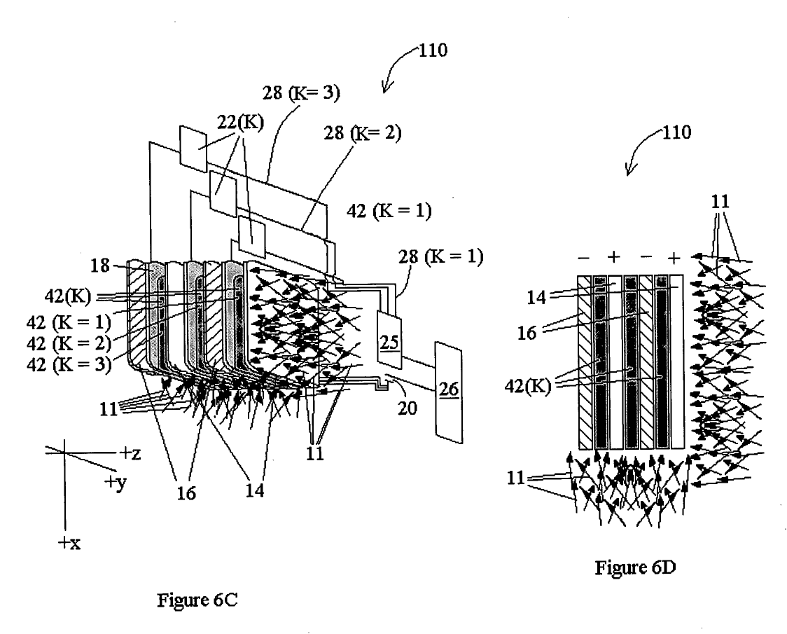

Referring further to the drawings, FIGS. 6A-6D schematically illustrate a stratified, single-pixel solid-state detector 110, having separating layers, operative as electrodes 14 and 16, in accordance with the present invention.

Accordingly, the stratified, single-pixel solid-state detector 110 is designed as a stack of the relatively thin solid-state-material layers 42(K), with thin positive and negative electrode layers 14 and 16, which may be deposited on the solid-state-material layers 42(K), separating the solid-state material layers 42(K), as they alternate between layers.

The detector 110 may be arranged for detecting the ionizing radiation 11 incident on planes orthogonal to the stratification, for example, the plane y;z, as seen in FIGS. 6A and 6B. Alternatively, the plane x;z or another edge plane may be used.

Additionally or alternatively, the detector 110 may be arranged for detecting the ionizing radiation 11 incident on the plane x;y parallel with the stratification, as seen in FIGS. 6C and 6D.

It will be appreciated that the stratified, single-pixel solid-state detector 110 may be arranged for detecting the ionizing radiation 11 incident on several planes, simultaneously.

Preferably, the detector 110 operates as a single unit, with no pixel information.

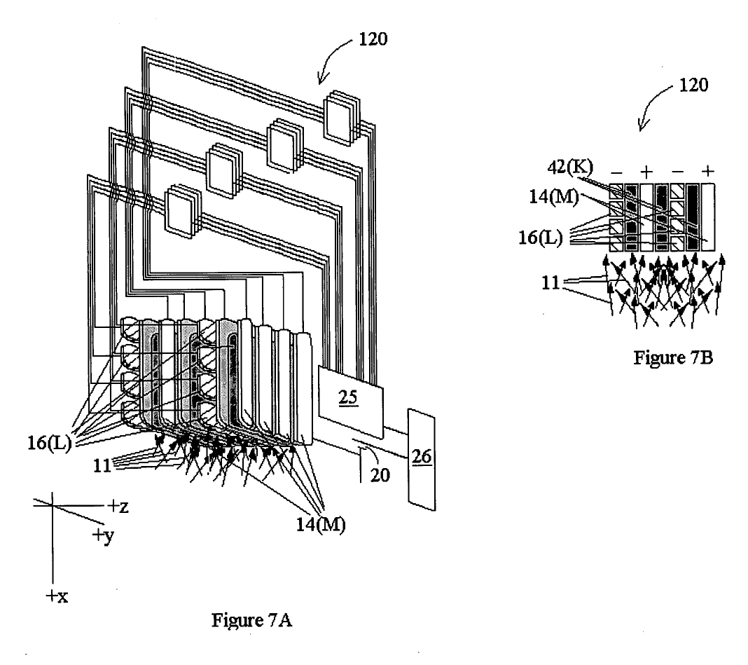

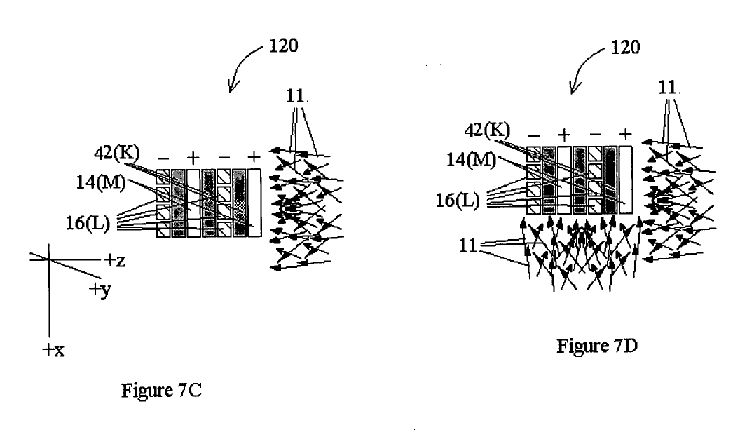

Referring further to the drawings, FIGS. 7A-7D schematically illustrate a stratified, single-pixel solid-state detector 120, having separating layers, operative as electrode-layer strips, and arranged for detecting the ionizing radiation 11 incident on planes parallel with and (or) orthogonal to the stratification, in accordance with the present invention.

Accordingly, the stratified, single-pixel, solid-state detector 120 may be designed as a stack of relatively thin solid-state-material layers, with thin electrode strips 14(M) and 16(L) between them, wherein the electrode strips form a weave: at one layer the electrode strips 14(M), which are positive, run in a first direction, and at the adjacent layer, the electrode strips 16(L), which are negative, run in a direction orthogonal to the first direction. In effect, the woven electrodes form a pixel-like structure from single-pixel solid-state-material layers. The pixel-like structure is applicable to the embodiment of FIG. 7C, wherein the ionizing radiation 11 is incident on the plane x;y, parallel with the stratification.

It will be appreciated that the stratified, single-pixel, solid-state detector 120 is also applicable for detecting the ionizing radiation 11 incident on other planes, as seen in FIGS. 7A, 7B, and 7D, but without the pixel-like effect.

It will be appreciated that the detectors of FIGS. 2A-7D may be optimized in accordance with the teaching of “Electron lifetime determination in semiconductor gamma detector arrays,” http://urila.tripod.comlhecht.htm, “GdTe and CdZnTe Crystal Growth and Production of Gamma Radiation Detectors,” http://members.tripod.com/˜urila/crystal.htm, and “Driving Energy Resolution to the Noise Limit in Semiconductor Gamma Detector Arrays,” Poster presented at NSS2000 Conference, Lyon France, 15-20 Oct. 2000, http://urila.tripod.com/NSS.htm, all by Uri Lachish, of Guma Science, P.O. Box 2104, Rehovot 76120, Israel, urila@internet-zahav.net, all of whose disclosures are incorporated herein by reference.

Accordingly, the detector may be a monolithic CdZnTe crystal, doped with a trivalent donor, such as indium. Alternatively, aluminum may be used as the trivalent donor. When a trivalent dopant, such as indium, replaces a bivalent cadmium atom within the crystal lattice, the extra electron falls into a deep trap, leaving behind an ionized shallow donor. The addition of more donors shifts the Fermi level from below the trapping band to somewhere within it. An optimal donor concentration is achieved when nearly all the deep traps become occupied and the Fermi level shifts to just above the deep trapping band.

Optimal spectral resolution may be achieved by adjusting the gamma charge collection time (i.e., the shape time) with respect to the electron transition time from contact to contact. Gamma photons are absorbed at different depth within the detector where they generate the electrons. As a result, these electrons travel different distances to the counter electrode and therefore produce a different external signal for each gamma absorption event. By making the shape time shorter than the electron transition time, from contact to contact, these external signals become more or less equal leading to a dramatic improvement in resolution.

Furthermore, for a multi-pixel detector, the electrons move from the point of photon absorption towards the positive contact of a specific pixel. The holes, which are far slower, move towards the negative contact, and their signal contribution is distributed over a number of pixels. By adjusting the gamma charge collection time (i.e., the shape time) with respect to the electron transition time from contact to contact, the detector circuit collects only the electrons' contribution to the signal, and the spectral response is not deteriorated by the charge of the holes.

For an optimal detector, crystal electrical resistively may be, for example, about 5×10⁸ ohm cm. The shape time may be, for example, 0.5×10⁻⁶ sec. It will be appreciated that other values, which may be larger or smaller are also possible.

It is expected that during the life of this patent many relevant solid-state detectors for ionizing radiation will be developed and the scope of the term a solid-state detector for ionizing radiation is intended to include all such new technologies a priori.

As used herein the term “about” refers to ±20%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A stratified solid-state detector, comprising:
a first solid-state-material layer, defining an x;y plane of an x;y;z coordinate system, and proximal and distal surfaces, proximally being the direction of positive z;
a second solid-state-material layer, distal to and parallel with said first layer and forming a stack therewith;
a first separating layer, arranged between said first and second solid-state-material layers; and
a bias, applied to said first and second solid-state-material layers, in parallel.

2. The stratified solid-state detector of claim 1, arranged for detecting ionizing radiation incident on said x;y plane.

3. The stratified solid-state detector of claim 1, arranged for detecting ionizing radiation incident on a plane orthogonal to said x;y plane.

4. The stratified solid-state detector of claim 1, arranged for detecting ionizing radiation incident on said x;y plane and on at least one plane orthogonal to it.

5. The stratified solid-state detector of claim 1, arranged for detecting ionizing radiation incident on said x;y plane and on at least two planes orthogonal to it.

6. The stratified solid-state detector of claim 1, wherein each of said solid-state-material layers has positive and negative electrode connections.

7. The stratified solid-state detector of claim 1, wherein said first separating layer is a first insulating layer.

8. The stratified solid-state detector of claim 1, and further including:
at least one other solid-state-material layer, distal to and parallel with said second layer; and
at least one other separating layer, arranged between said second and at least one other solid-state-material layers,
wherein said bias is applied to said at least one other solid-state-material layer, in parallel with said first and second solid-state-material layers.

9. The stratified solid-state detector of claim 8, wherein said at least one other separating layer is at least one other insulating layer.

10. The stratified solid-state detector of claim 8, wherein said first and at least one other separating layers are electrode layers, of opposite senses, and further including:
a proximal-most electrode layer, arranged on said proximal surface of said first solid-state-material layer, and being of an opposite sense to said electrode layer forming said first separating layer; and
a distal-most electrode layer, arranged on a distal surface of said at least one other solid-state-material layer, and being of an opposite sense to said electrode layer forming said at least one other separating layer.

11. The stratified solid-state detector of claim 10, wherein said electrode layers are formed as electrode layer strips.

12. The stratified solid-state detector of claim 11, wherein positive electrode layer strips are arranged orthogonal to negative electrode layer strips.

13. The stratified solid-state detector of claim 1, and further including:
a plurality of additional solid-state-material layers, distal to and parallel with said second layer; and
a plurality of additional separating layers, each arranged between adjacent solid-state-material layers, so that every two adjacent solid-state-material layers have one of said separating layers, between them,
wherein said bias is applied to said plurality of additional solid-state-material layers, in parallel with said first and second solid-state-material layers.

14. The stratified solid-state detector of claim 13, wherein said plurality of additional separating layers are a plurality of additional insulating layers.

15. The stratified solid-state detector of claim 13, wherein said separating layers are electrode layers, and further including:
a proximal-most electrode layer, arranged on said proximal surface of said first solid-state-material layer; and
a distal-most electrode layer, arranged on a distal surface of a distal-most of said plurality of additional solid-state-material layers,
wherein adjacent electrode layers have opposite senses.

16. The stratified solid-state detector of claim 15, wherein said electrode layers are formed as electrode-layer strips.

17. The stratified solid-state detector of claim 16, wherein positive electrode-layer strips are arranged orthogonal to negative electrode-layer strips.

18. The stratified solid-state detector of claim 1, wherein said solid-state-material layers are pixellated.

19. The stratified solid-state detector of claim 1, wherein signals of each of said solid-state-material layers are analyzed individually.

20. The stratified solid-state detector of claim 1, wherein signals of each of said solid-state-material layers are analyzed individually, to provide depth-penetration information.

21. The stratified solid-state detector of claim 1, wherein said solid-state-material layers are pixellated, and signals of each pixel in each of said solid-state-material layers are analyzed individually.

22. A method of detecting ionizing radiation, comprising:
providing a stratified solid-state detector, which comprises:
a first solid-state-material layer, defining an x;y plane of an x;y;z coordinate system, and proximal and distal surfaces, proximally being the direction of positive z;
a second solid-state-material layer, distal to and parallel with said first layer and forming a stack therewith; and
a first separating layer, arranged between said first and second solid-state-material layers;
applying a bias to said first and second solid-state-material layers, in parallel;
detecting ionizing radiation, incident on said detector.
